(19) United States
(12) Patent Application Publication
(10) Pub. No.: US 2015/0066536 A1
(43) Pub. Date: Mar. 5, 2015

(54) METHOD AND APPARATUS FOR GENERATING HEALTH QUALITY METRICS

(71) Applicant: McKesson Financial Holdings, Hamilton (BM)

(72) Inventor: Rick Spates, Canton, GA (US)

(73) Assignee: McKesson Financial Holdings, Hamilton (BM)

(21) Appl. No.: 14/012,636

(22) Filed: Aug. 28, 2013

(51) Int. Cl. G06F 19/00; G06F 17/30; G06F 17/27

(52) U.S. Cl. CPC G06F 19/322; G06F 17/2705; G06F 17/30731; G06F 17/30424
USPC 705/3

(57) ABSTRACT

A method, apparatus and computer program product are therefore provided for generating health quality measurements. In this regard, the method, apparatus, and computer program product may implement a health quality measurement by receiving one or more health quality measurement definitions. Each health quality measurement may include markup language definitions defining one or more calculation parameters for a health quality metric. The method may also include parsing, using a processor, the one or more health quality measurement definitions to derive a semantic representation of the one or more calculation parameters, parsing the semantic representation of the one or more calculation parameters in conjunction with a health quality measurement ontology derived from at least the one or more health quality measurement definitions to generate a health quality measurement calculator application, and executing the health quality measurement calculator application against a set of healthcare data to determine the health quality metric for the healthcare data.

### TECHNOLOGICAL FIELD

An example embodiment of the present invention relates generally to processing markup language documents, and, more particularly, to a method and apparatus for generating health quality metrics from health quality measurement definitions provided in a markup language.

### BACKGROUND

As more and more medical providers migrate their records to electronic medical records systems, more and more robust methods for reviewing and analyzing this data have been developed. In particular, electronic medical record storage allows for a variety of quality metrics and analytics to be generated from medical records datastores. In addition, changes in healthcare laws have resulted in certain entities, such as the Department of Health and Human Services (HHS) requesting more and more data from medical providers to ensure that certain quality standards are met.

However, due to the relatively recent development of these medical record systems, a uniform standard for data storage has not yet been developed. Communication among different providers typically requires significant development time to ensure that systems can efficiently exchange data. One method of exchange of data involves the use of medical records and metric techniques defined with self-describing markup languages, such as Extensible Markup Language (XML). Examples of implementing quality metrics using such markup languages include Health Quality Measure Format (HQMF) and the eMeasure XML document published by HHS. Adoption of these standards has also been urged by entities such as the National Quality Forum (NQF).

Since different medical records systems store records data in different formats, application of these metrics to different systems requires manual development of software for each different metric in order to extract the relevant data from the electronic medical records and to calculate the appropriate metrics. Any change in a particular metric may require a complete update and redesign of utilities to extract the relevant data from the records datastore. Through applied effort, ingenuity, and innovation, Applicant has solved many of these identified problems by developing a solution that is embodied by the present invention, which is described in detail below.

### BRIEF SUMMARY

Accordingly, a method, apparatus and computer program product are therefore provided according to an example embodiment of the present invention in order to provide a semantic parser to generate health quality measurement calculators from health quality measurement definition documents provided in as a set of markup language definitions. In this regard, the method, apparatus, and computer program product of an example embodiment may generate the semantic parser by analyzing a plurality of health quality measurement definitions. This analysis may derive a common schema for the set of health quality measurement definitions and an ontology for the health quality measurement definitions. The common schema may be used to generate a parser that converts a document provided according to the schema into a semantic representation. The common schema may also be decorated with code portions to facilitate extraction of relevant data from a medical record data store. The decorated common schema and the parser may be used in conjunction with one another to generate the semantic parser. The semantic parser may take a health quality measurement definition document as input and generate an application, that, when executed against a set of medical records, provides a metric as defined by the definition document.

Embodiments may include a method for implementing a health quality measurement. The method may include receiving one or more health quality measurement definitions. At least a portion of each health quality measurement may include markup language definitions defining one or more calculation parameters for a health quality metric. The method may also include parsing, using a processor, the one or more health quality measurement definitions to derive a semantic representation of the one or more calculation parameters, parsing the semantic representation of the one or more calculation parameters in conjunction with a health quality measurement ontology derived from at least the one or more health quality measurement definitions to generate a health quality measurement calculator application, and executing the health quality measurement calculator application against a set of healthcare data to determine the health quality metric for the healthcare data. The health quality measurement definitions and the semantic representation may be parsed by a semantic parser. The semantic parser may be generated by a method include receiving a plurality of health quality measurement definitions. The plurality of health quality measurement definitions may include at least the one or more health quality measurement definitions. Each of the plurality of health quality measurement definitions may be associated with a respective set of markup language definitions. Generation of the semantic parser may also include deriving a health quality measurement schema for the plurality of health quality measurement definitions using at least the respective sets of markup language definitions, deriving the health quality measurement ontology from the plurality of health quality measurement definitions, decorating the health quality measurement schema with one or more source code portions to generate a decorated schema, and generating the semantic parser by compiling the decorated schema. A first portion of the decorated health quality measurement schema may include program code that, when compiled and executed, receives the one or more health quality measurement definitions and generates the semantic representation of the one or more health quality measurement definitions. In some embodiments, a second portion of the decorated health quality measurement schema includes program code that, when compiled and executed, generates the health quality measurement calculator by parsing the semantic representation. The semantic representation may be a Resource Description Framework (RDF) data model. The set of healthcare data may be stored in a semantic representation format. Parsing the semantic representation may include executing a query against the semantic representation of the one or more health quality measurement definitions to determine whether the semantic representation satisfies one or more criteria. The one or more criteria may define one or more queries to be executed against the set of healthcare data. Executing the health quality measurement calculator application may include executing the one or more queries against the set of healthcare data.

Embodiments may also include an apparatus comprising processing circuitry. The processing circuitry may be configured to receive one or more health quality measurement definitions. At least a portion of each health quality measurement may include markup language definitions defining one or more calculation parameters for a health quality metric. The processing circuitry may also be configured to parse the one or more health quality measurement definitions to derive a semantic representation of the one or more calculation parameters, to parse the semantic representation of the one or more calculation parameters in conjunction with a health quality measurement ontology derived from at least the one or more health quality measurement definitions to generate a health quality measurement calculator application, and to execute the health quality measurement calculator application against a set of healthcare data to determine the health quality metric for the healthcare data. The health quality measurement definitions and the semantic representation may be parsed by a semantic parser, and the apparatus may be configured to generate the semantic parser by receiving a plurality of health quality measurement definitions. The plurality of health quality measurement definitions may include at least the one or more health quality measurement definitions. Each of the plurality of health quality measurement definitions may be associated with a respective set of markup language definitions. The apparatus may be further configured to generate the semantic parser by deriving a health quality measurement schema for the plurality of health quality measurement definitions using at least the respective sets of markup language definitions, deriving the health quality measurement ontology from the plurality of health quality measurement definitions, decorating the health quality measurement schema with one or more source code portions to generate a decorated schema, and generating the semantic parser by compiling the decorated schema. A first portion of the decorated health quality measurement schema may include program code that, when compiled and executed, receives the one or more health quality measurement definitions and generates the semantic representation of the one or more health quality measurement definitions. A second portion of the decorated health quality measurement schema may include program code that, when compiled and executed, generates the health quality measurement calculator by parsing the semantic representation. The semantic representation may be a Resource Description Framework (RDF) data model. The set of healthcare data may be stored in a semantic representation format. The apparatus may be configured to parse the semantic representation by executing a query against the semantic representation of the one or more health quality measurement definitions to determine whether the semantic representation satisfies one or more criteria. The one or more criteria may define one or more queries to be executed against the set of healthcare data. Executing the health quality measurement calculator application may include executing the one or more queries against the set of healthcare data.

Embodiments may also include a computer program product including at least one non-transitory computer-readable storage medium bearing computer program instructions embodied therein for use with a computer. The computer program instructions may include program instructions configured to receive one or more health quality measurement definitions, at least a portion of each health quality measurement comprising markup language definitions defining one or more calculation parameters for a health quality metric. The instructions may further be configured to parse the one or more health quality measurement definitions to derive a semantic representation of the one or more calculation parameters, to parse the semantic representation of the one or more calculation parameters in conjunction with a health quality measurement ontology derived from at least the one or more health quality measurement definitions to generate a health quality measurement calculator application, and to execute the health quality measurement calculator application against a set of healthcare data to determine the health quality metric for the healthcare data. The health quality measurement definitions and the semantic representation may be parsed by a semantic parser. The program instructions may be also configured to generate the semantic parser by receiving a plurality of health quality measurement definitions. The plurality of health quality measurement definitions may include at least the one or more health quality measurement definitions. Each of the plurality of health quality measurement definitions may be associated with a respective set of markup language definitions. Generation of the semantic parser may also include deriving a health quality measurement schema for the plurality of health quality measurement definitions using at least the respective sets of markup language definitions, deriving the health quality measurement ontology from the plurality of health quality measurement definitions, decorating the health quality measurement schema with one or more source code portions to generate a decorated schema, and generating the semantic parser by compiling the decorated schema.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a block diagram of a memory comprising a plurality of modules for generating health quality metrics in accordance with example embodiments of the present invention;

FIG. 3 is a data flow diagram illustrating the development of a derived health quality measurement schema in accordance with example embodiments of the present invention;

FIG. 4 is a data flow diagram illustrating the processing of a derived health quality measurement schema by a decorator module in accordance with embodiments of the present invention;

FIG. 5 is a data flow diagram illustrating the generation of a semantic parser module in accordance with embodiments of the present invention;

FIG. 6 is a data flow diagram illustrating a first pass of a semantic parser module in accordance with embodiments of the present invention;

FIG. 7 is a data flow diagram illustrating a second pass of a semantic parser module in accordance with embodiments of the present invention;

FIG. 8 is a data flow diagram illustrating the use of a health quality measurement calculator application to determine a health quality metric result in accordance with embodiments of the present invention;

FIG. 9 is a flow diagram of an example method for generating a semantic parser in accordance with example embodiments of the present invention; and

FIG. 10 is a flow diagram of an example method for generating a health quality measurement calculator application using a semantic parser in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### OVERVIEW AND DEFINITIONS

A method, apparatus and computer program product are provided in accordance with an example embodiment of the present invention in order to parse health quality measurement definition documents to generate modules that may be used to derive various healthcare metrics from sets of healthcare data. In this regard, a method, apparatus and computer program product of an example embodiment may parse health quality measurement definition documents provided in a markup language format using a semantic parser to generate a software module that extracts data from a particular medical records datastore. Parsing of the health quality measurement definition documents may advantageously allow for dynamic creation of software modules for generation of the health quality measurements.

As used herein, the term “markup language” should be understood to refer to languages that include annotated data within the document that is syntactically distinguishable from the text. An example markup language as utilized by the systems and methods described herein may include structured XML. Markup languages may include a defined “schema”. As used herein, the term schema should be understood to refer to a set of constraints on the structure and content of a particular document or set of documents (e.g., an XML schema), above and beyond the basic syntactical constraints imposed by markup within the document itself. These constraints may be expressed using some combination of grammatical rules governing the order of elements, Boolean predicates that the content must satisfy, data types governing the content of elements and attributes, and more specialized rules such as uniqueness and referential integrity constraints.

### Example Apparatus

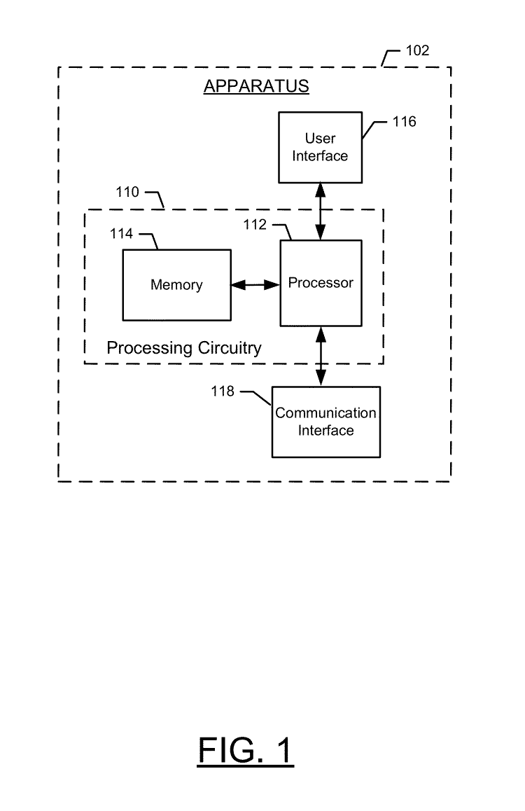

FIG. 1 illustrates a block diagram of an apparatus 102 in accordance with some example embodiments. The apparatus 102 may be any computing device capable of receiving health quality measurement definition documents to generate a semantic parser and/or utilize a semantic parser to generate a health quality measurement calculator module. In some particular embodiments, the apparatus 102 may be configured to perform or otherwise assist with medical record management operations. For example, the apparatus 102 may be implemented on a computing device that generates analytics or statistical measurements and/or reports to perform measurements of health care quality metrics or to report compliance with quality monitoring requirements. Although generally presented with respect to a single apparatus, it should be appreciated that multiple apparatuses could also be employed with respect to embodiments of the present invention. For example, a first apparatus might generate a semantic parser and the semantic parser might be provided to a second apparatus for use in generating a health quality measurement calculator module. It should be readily appreciated that various additional or alternative configurations of an apparatus or apparatuses may also be employed to facilitate these operations. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

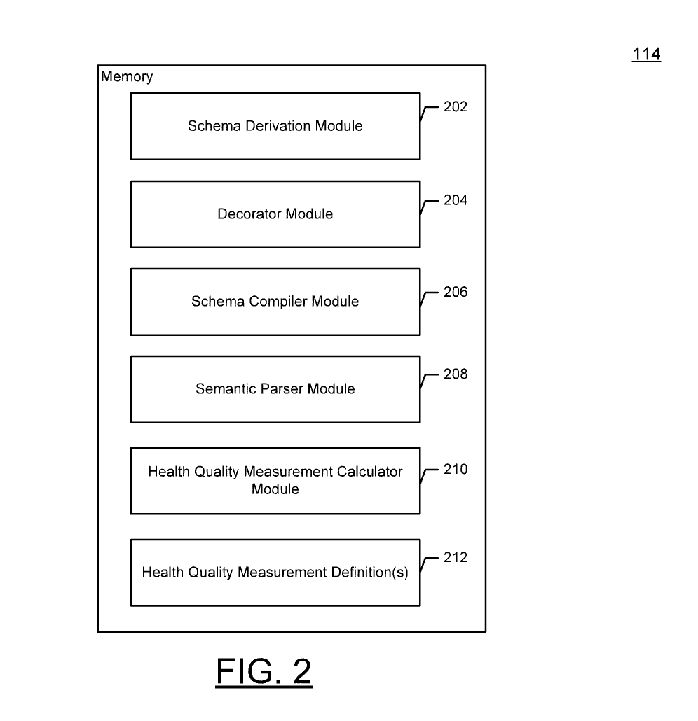

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. An example set of modules that may be embodied in the memory 114 are described further below with respect to FIG. 2. The memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

FIG. 2 is a block diagram of a memory 114 comprising a plurality of modules for generating health quality metrics in accordance with example embodiments of the present invention. As described above, the memory 114 may store a plurality of modules, applications, programs, or the like for facilitating the operation of example embodiments. It should be readily appreciated that while the instant example describes these modules as software applications, these applications act in concert with other elements of an apparatus (e.g., a processor) to perform aspects of the example embodiments. It should also be readily apparent that the modules described herein as resident within the memory could also be implemented as hardware elements such as field-programmable gate arrays (FPGAs), application specific interface circuits (ASICs), or the like.

The modules present within the memory 114 may include a schema derivation module 202, a decorator module 204, a schema compiler module 206, a semantic parser module 208, and/or a health quality measurement calculator module 210. Although the modules 202-210 are described as stored within the memory simultaneously, it should be appreciated that embodiments may involve generation or consumption of one or more of these elements stored in memory. For example, the schema derivation module 202, the decorator module 204, and the schema compiler module 206 may operate to generate the semantic parser module 208 from a set of input health quality measurement definitions 212.

The schema derivation module 202 may function to receive as input a set of health quality measurement definitions and derive a schema for the health quality measurement definitions. For example, the health quality measurement definitions 212 may be provided as a set of XML documents, which specify the different elements of a set of electronic medical records that make up the health quality measurement definitions. The health quality measurement definitions may specify particular values and codes to be extracted from the electronic medical records and used to calculate a particular metric. For example, the health quality measurement definitions may specify particular types of tests (e.g., a streptococcus test), patient demographics (e.g., age, weight, height, gender), encounter types (e.g., clinic visit, specialist visit, hospital admit), or the like, and a relationship between these values (e.g., using a particular term or terms as a numerator or denominator in a calculation). In some embodiments, each health quality measurement is provided as a separate XML document, and a set of codes (e.g., numerical values related to particular procedures, tests, and the like) as another separate document.

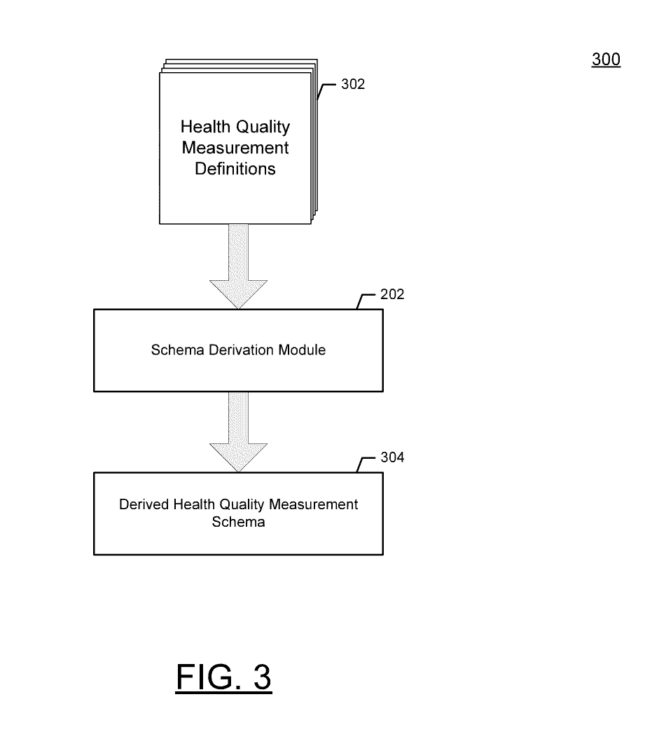

The schema derivation module 202 may receive these XML documents, and analyze the documents to generate a schema that specifies the structure of the set of XML documents. One example of such a schema derivation module is the open-source multi-format schema converter tool “trang”, published by the Thai Open Source Software Center Ltd. Although the instant example relates to the use of trang, it should be appreciated that other schema interpreters may be used to derive a schema from the set of input documents. The schema derivation module 202 may infer a single schema from a plurality of the input documents. In some embodiments, the output of the schema derivation module 202 is a schema in a RELAX NG (REgular LAnguage for XML Next Generation) format. This derived schema may be used as input to the decorator module 204, which utilizes the derived schema to generate a semantic parser, such as the semantic parser module 208. An example data flow for generating the derived schema is described further below with respect to FIG. 3.

The decorator module 204 may receive the derived schema produced by the schema derivation module 202 and create a set of documents that may be used by the schema compiler module 206 to generate the semantic parser module 208. The decorator module 204 may begin by “unfolding” the schema, in which all elements of the schema are defined by the schema derivation module 202, such that no elements of the derived schema are left as implicit. This action may make working with the schema easier.

The decorator module 204 may then “decorate” elements of the derived schema with tokens that represent particular code portions. For example, the decorator module 204 may add code portions to the derived schema to map elements of the schema to a particular semantic representation of the schema. For example, each element of the schema (e.g., an XML object) may be mapped to a semantic representation provided in a Resource Description Framework (RDF) format. In this regard, the code portions may map a given set of input XML documents that correspond to the schema (e.g., one of the health quality measurement definition documents described above) to a set of RDF criteria that describe to which particular data elements of the electronic medical record datastore the input health quality measurement definition pertains. This decorated schema may be viewed as a set of “source code” that may be used by the schema compiler module 206 to generate part of the semantic parser module 208. For example, the decorator module may add Java® code to elements of the schema to map the schema elements to an RDF model, which defines certain RDF criteria that correspond to the XML elements present within the various health quality measurement definitions.

The decorator module 204 may be further configured to decorate a version of the derived schema with code that maps possible sets of RDF criteria to queries against a particular medical record datastore. In some embodiments, the medical record datastore may already be mapped to an RDF model. Some example embodiments for converting a medical records datastore to a semantic representation model are described in U.S. patent application Ser. No. 12/947,425, filed May 17, 2012 by Willard et al., entitled “METHOD, APPARATUS AND COMPUTER PROGRAM PRODUCT FOR UTILIZING DYNAMICALLY DEFINED JAVA IMPLEMENTATIONS FOR CREATION OF AN EFFICIENT TYPED STORAGE” and U.S. patent application Ser. No. 12/566,149, filed Sep. 24, 2009 by Alden et al., entitled “METHOD, APPARATUS AND COMPUTER PROGRAM PRODUCT FOR FACILITATING PATIENT PROGRESSION TOWARD DISCHARGE”, which are herein incorporated by reference in their entirety. The specific code added to the schema during the decoration process may depend upon the particular set of medical record systems to be accessed, as the same schema may map differently to different medical record systems depending upon the implementation of those medical record systems. The decorator module 204 may be configured and/or programmed by a developer to add the appropriate code “decorations” for the particular semantic parser module to be generated.

The decorator module 204 may also be configured to generate a health quality measurement ontology. The health quality measurement ontology may provide a description of the classes, properties and relations between classes that apply in the case of any of the health quality measurement definitions that are used to generate the health quality measurement schema, or corresponding semantic representations of those classes. The health quality measurement ontology may be used to assist in querying a semantic representation data model during parsing. In particular, class hierarchy information may only be known within the ontology and the properties of a class (e.g., corresponding to the attributes of an element in XML) are also only known within the ontology. As such, a query may be constructed containing assertions about the state of the instances in the semantic representation of a datastore (e.g., “encounterA, hasObservation, observationB”. “observationB icd9Code “1234””) and assertions about the structure of the instances (e.g., “x subClassOf y”).

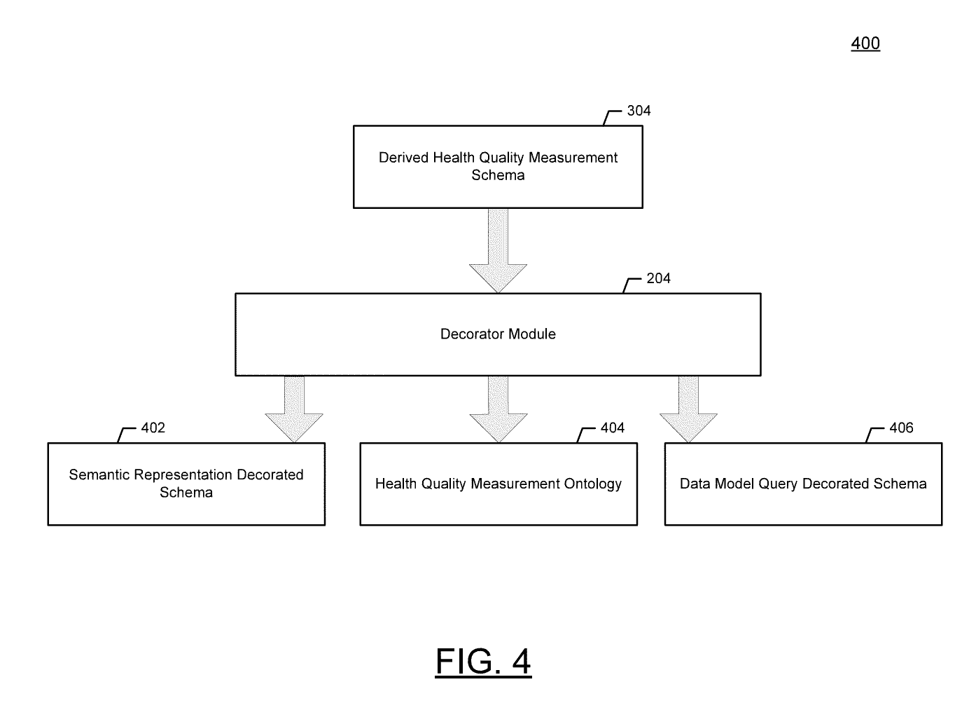

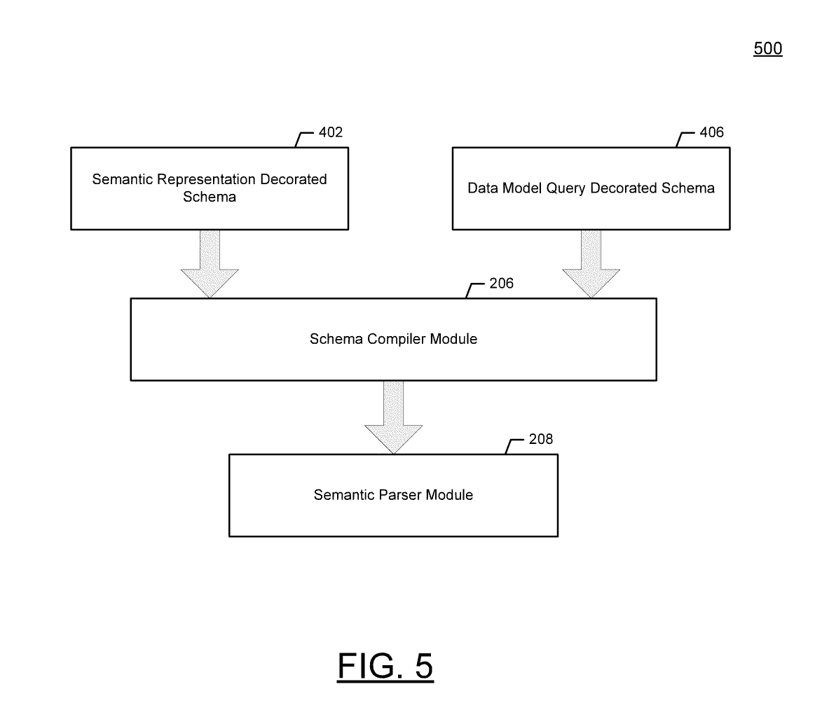

The health quality measurement ontology may be utilized by a semantic parser module during the parsing process to define elements of a semantic representation model. In this regard, the semantic representation model (e.g., an RDF model) may specify a set of criteria and actions to be performed upon the occurrence of the criteria, and the health quality measurement ontology may define the terms of the model. For example, the ontology may be considered to include a set of metadata describing the elements of the semantic representation model employed by the semantic parser. An example data flow for processing the derived health quality measurement schema using the decorator module is described further below with respect to FIG. 4. The schema compiler module 206 may be utilized to generate the semantic parser module 208 using the decorated health quality measurement schema and the health quality measurement semantic representation schema. An example data flow for generating the semantic parser module 208 using the schema compiler module 206 is described further below with respect to FIG. 5.

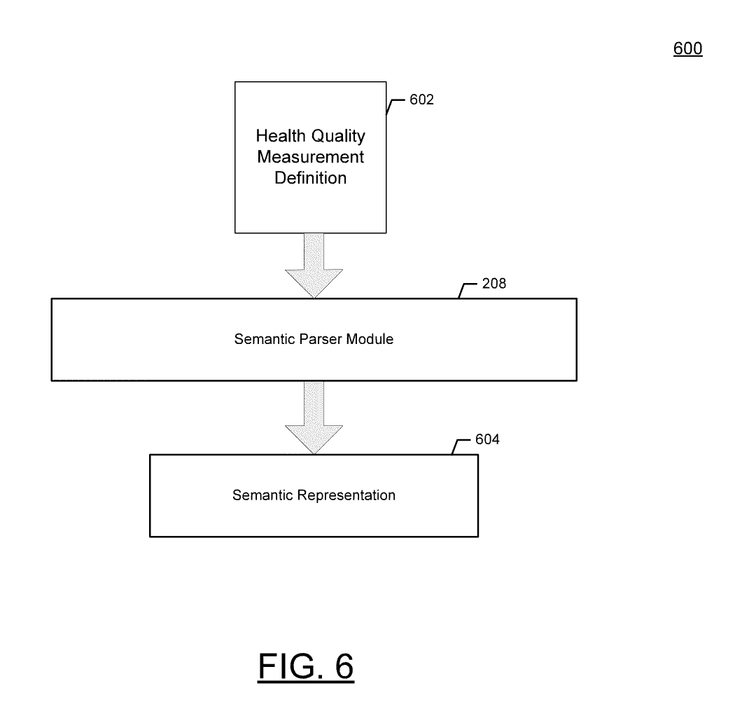

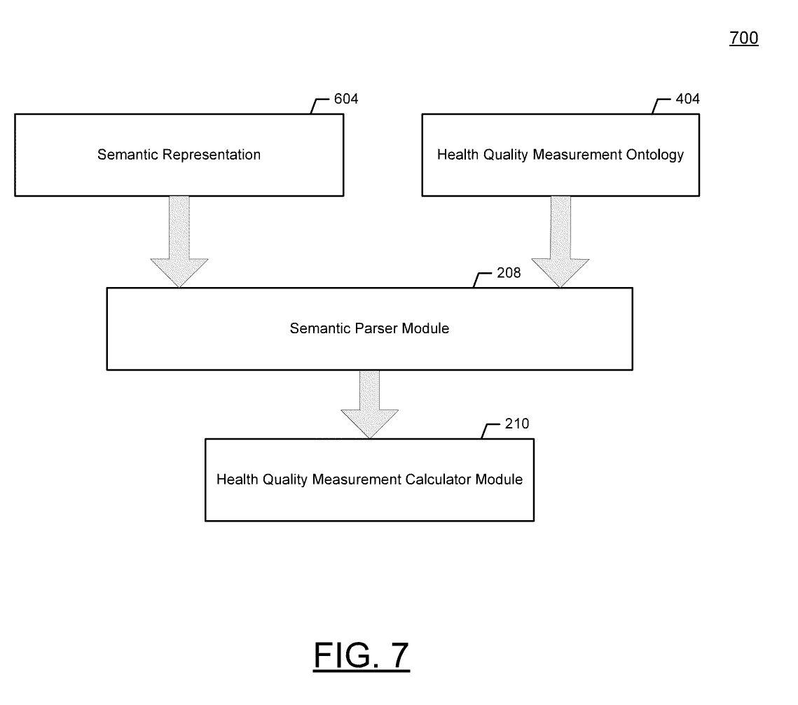

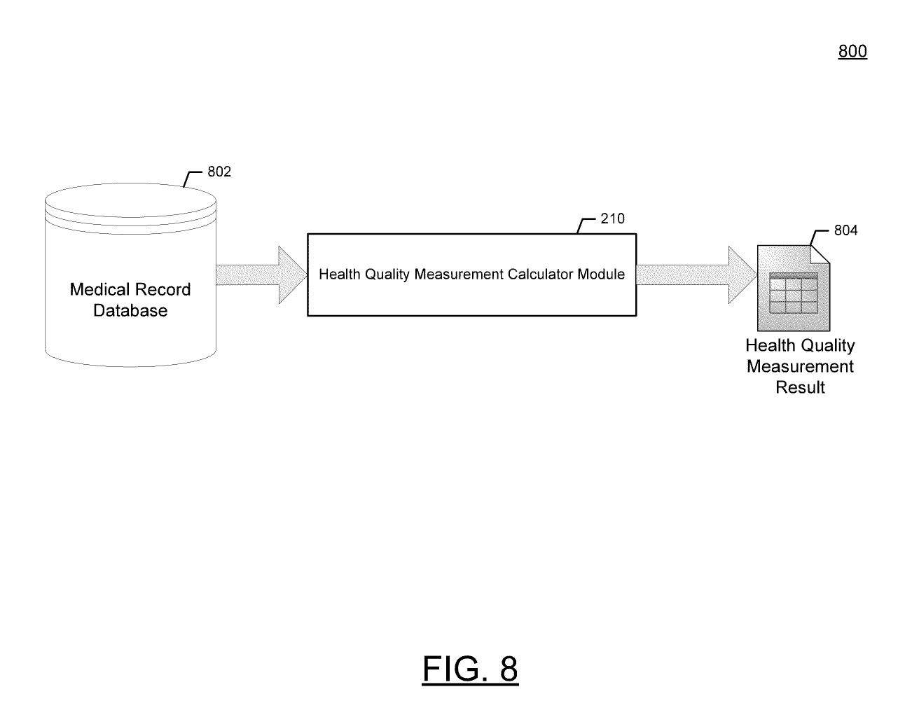

The semantic parser module 208 may be utilized to generate one health quality measurement calculator module(s) 210 when provided with an input health quality measurement definition document 212. The health quality measurement calculator module 210 may function to map the particular health quality measurement definition document 212 to a set of medical records to calculate the particular metric associated with the health quality measurement definition document. An example data flow for generating the health quality measurement calculator module 210 is described further below with respect to FIGS. 6 and 7. An example data flow for determining a particular metric using a health quality measurement calculator module 210 is described further below with respect to FIG. 8.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

As described above, example embodiments may include both generation of a semantic parser module and using the semantic parser module to process health quality measurement definition documents to extract data from a particular medical records datastore. FIGS. 3-5 describe an example of a data flow for generating a semantic parser module, while FIGS. 6-8 describe an example of a data flow for using the semantic parser module to process the health quality measurement definition documents using the semantic parser.

### Example Semantic Parser Generation

Turning first to FIGS. 3-5, the process for generating the semantic parser will be described. FIG. 3 illustrates a data flow 300 for generating a derived health quality measurement schema in accordance with example embodiments of the present invention. As described above with respect to FIG. 2, embodiments may derive a schema from a set of input health quality measurement definition documents 302 provided in a markup language format, such as XML. For example, the health quality measurement definition documents 302 may include markup language describing the elements and attributes of a particular metric. These elements and attributes may be provided as a series of markup language definitions, which include both data and metadata used to interpret the metric. These definitions may include, but are not limited to, tags, attributes, elements, and associated attendant values of each. A schema convertor such as “trang” may be used to derive a schema from an input set of definition documents 302 to generate a derived health quality measurement schema 304. As a specific example, the input documents provided to the schema derivation module 202 may be provided in an XML format, and the derived health quality measurement schema 304 may be provided in a RELAX NG format.

FIG. 4 illustrates a data flow 400 for processing a derived health quality measurement schema 304 by a decorator module 204 in accordance with embodiments of the present invention. As an initial matter, embodiments of the decorator module 204 may optionally modify the derived health quality measurement schema by “unfolding” the schema as described above, to ensure that all elements of the schema are explicitly defined and no elements are left as implicit. This preliminary step may place the health quality measurement schema in an easier format for processing to generate the outputs. For example, the decorator module 204 may be designed to generate classes within the health quality measurement ontology using data elements explicitly defined within the schema. As such, generation of these classes may include the optional step of modifying the schema to ensure that no elements are left implicit. It should be readily appreciated that some alternative embodiments may perform this “unfolding” process during generation of the classes within the health quality measurement ontology, or prior to providing the schema to the decorator module 204. Additionally or alternatively, some embodiments may possess the capability to generate a class using implicitly defined elements.

As described above, the decorator module 204 may receive the derived health quality measurement schema 304 and generate a set of outputs that are utilized by a schema compiler module. These outputs may include a semantic representation decorated schema 402, a health quality measurement ontology 404, and a data model query decorated schema 406. Each of these output objects will now be described in further detail.

As described above with respect to FIG. 2, the semantic representation decorated schema 402 may include the derived schema automatically decorated with code portions that map the elements of the schema to a semantic representation model (e.g., an RDF model). The decorator module 204 may be configured to automatically add code to the derived schema to map the elements within the schema to the semantic representation format. For example, when the semantic representation decorated schema 402 is compiled, the compiled program may receive a health quality measurement definition document as input, and provide a semantic representation of the input document as output (e.g., an RDF representation of the input health quality measurement document). The following is an example of an decorated schema that includes code (e.g., Java® code) for converting an input XML document to an RDF representation such as may be produced by the decorator module 204:

```
TABLE 1
  <define name=“encounter”>
    <c:java>mm.println(name+“ rdf:type qdm:“+$localName+” .”);</c:java>
    <c:java>mm.println(parentName+“ qdm:has“+$localName+” “+name+” . ”);</c:java>
    <c:java>mm.println(“#”+$localName);</c:java>
    <element>
      <name ns=“urn:hl7-org:v3”>encounter</name>
      <attribute name=“classCode”> <data type=“NCName” c:alias=“var11”
/><c:java>mm.println(““+name+” qdm:classCode \”“+var11+”\“\hat{ }\hat{ }xsd:NCName . ”
);</c:java></attribute>
      <optional>
        <attribute name=“isCriterionInd”>
          <data type=“boolean” c:alias=“var11a” />
              <c:java>mm.println(““+name+” qdm:isCriterionInd
\”“+var11a+”/“\hat{ }\hat{ }xsd:boolean . ”);</c:java>
        </attribute>
      </optional>
      <attribute name=“moodCode”> <data type=“NCName” c:alias=“var12”
/><c:java>mm.println(““+name+” qdm:moodCode \”“+var12+”\“\hat{ }\hat{ }xsd:NCName . ”
);</c:java></attribute>
      <optional>
        <ref name=“id” />
      </optional>
      <choice>
        <zeroOrMore>
          <choice>
            <ref name=“code” />
            <ref name=“effectiveTime” />
            <ref name=“participant” />
            <ref name=“sourceOf” />
            <ref name=“title” />
            <ref name=“dischargeDispositionCode” />
          </choice>
        </zeroOrMore>
        <ref name=“priorityCode” />
      </choice>
    </element>
  </define>
```

This example portion of a semantic representation decorated schema 402 includes code portions that write elements of an input schema file to a set of semantic representation “triples” (e.g., data structures that contain an element name, an attribute type for the element, and a value for the attribute) when presented with an input set of data encoded in a compatible markup language format (e.g., a health quality measurement definition document). This decorated schema may be employed as part of the semantic parser module to convert a received health quality measurement definition document into a semantic representation format, an example of which is described further below with respect to FIG. 6.

As described above, the decorator module 204 may also generate a data model query decorated schema 406. The data model query decorated schema 406 may include a version of the derived schema that is decorated with code that maps particular elements of the schema to particular elements of a semantic representation of a datastore. For example, the data model query decorated schema 406 may include tokens that denote code to perform queries against the results of a first past compiler (e.g., an RDF representation of an input health quality measurement definition as produced by the compiled semantic representation schema). The results of these queries, in conjunction with a set of lookup codes and an ontology derived from the original set of health quality measurement definitions may establish criteria for querying a medical records datastore, with the end result of this “second pass” being a set of queries that extract the data appropriate for the input health quality measurement definition from the medical records datastore. The data model query decorated schema 406 may also be employed as part of a semantic parser module to receive a health quality measurement definition document that has been converted to a semantic representation format (e.g., an RDF representation). The following is an example of a portion of a schema decorated with code for processing the output of the “first pass” of a semantic parser:

```
TABLE 2
  <define name=“act”>
    <element>
      <name ns=“urn:hl7-org:v3”>act</name>
      <optional>
        <attribute name=“actionNegationInd”>
          <data type=“boolean” />
        </attribute>
      </optional>
      <attribute name=“classCode”>
        <data type=“NCName” />
      </attribute>
      <optional>
        <attribute name=“isCriterionInd”>
          <data type=“boolean” />
        </attribute>
      </optional>
      <attribute name=“moodCode”>
        <data type=“NCName” />
      </attribute>
      <oneOrMore>
        <choice>
          <text />
          <ref name=“code” />
          <ref name=“derivationExpr” />
          <ref name=“effectiveTime” />
          <ref name=“id” />
          <ref name=“participant” />
          <ref name=“sourceOf” />
          <ref name=“templateId” />
          <ref name=“title” />
          <ref name=“value” />
          <ref name=“ERROR” />
          <ref name=“repeatNumber” />
        </choice>
      </oneOrMore>
  <spcc:set>
          <spcc:criteria>
# Population Criteria Section:
# laboratory test performed pattern
# Laboratory test performed: Group A Streptococcus Test
# supports both:
# less than or equal 3 day(s) starts before or during encounter
# less than or equal 3 day(s) starts after end of encounter
# pauseQuantity implies ‘after end of’
#
  select * {
#this is an act
            ?this :hasTemplateId ?template ;
              :hasId ?id ;
              :hasCode ?code ;
              :hasSourceOf ?srcOf .
            ?id :root “AF9EE784-50CF-413F-9082-
            41A3330511A1”\hat{ }\hat{ }xsd:string .
            ?template :root “2.16.840.1.113883.3.560.1.5”\hat{ }\hat{ }xsd:
            NMTOKEN .
            ?code :code “30954-2”\hat{ }\hat{ }xsd:NMTOKEN ;
              :codeSystem “2.16.840.1.113883.6.1”\hat{ }\hat{ }xsd:NMTOKEN .
            ?srcOf :hasObservation ?obs .
            ?obs :isCriterionInd “true”\hat{ }\hat{ }xsd:boolean ;
              :moodCode “EVN”\hat{ }\hat{ }xsd:NCName ;
              :hasCode ?code2 ;
              :hasStatusCode ?statCode ;
              :hasSourceOf ?srcOf2 .
            ?code2 :code ?resultCode .
            ?statCode :code?statusCode .
            optional {
              ?srcOf2 :inversionInd ?pauseInversion .
            }
            ?srcOf2 :typeCode ?pauseType ;
              :hasPauseQuantity ?pauseQua .
            ?pauseQua :type “IVL_PQ”\hat{ }\hat{ }xsd:NCName ;
              :hasHigh ?high .
            ?high :inclusive ?pauseInclusive ;
              :unit ?pauseUnit ;
              :value ?pauseValue .
}
                </spcc:criteria>
                <spcc:action>
                  <c:java>String a=“abc”; </c:java>
                  if (a.equals(“abc”)){ }// this line gets lost
                  <spcc:spql>
                    ?result qi:hasEncounter ?encounter .
                    ?result qi:loincCode ?ptResultCode .
                    ?result qdm:hasTaxa ?taxonomyResultCode .
                    filter ( extf:codeMatch (?resultCode,
                    ?taxonomyResultCode,
?ptResultCode) )
                  </spcc:spql>
                </spcc:action>
              </spcc:set>
```

As can be readily discerned from Table 2, the data model query decorated schema 406 may include one or more “spcc:” tags which direct a semantic parser compiler, such as the schema compiler 206, to insert certain code portions or otherwise perform directives. For example, “spcc:action” tags may indicate a particular portion of the schema that pertains to an RDF action to be taken to employ a query, and “spcc:spql” tags may indicate portions that should be processed as SPARQL queries by a semantic parser compiler.

In addition to generating the decorated schemas which may be used to generate a semantic parser module as described above, the decorator module may also generate an ontology including metadata for the semantic representation model defined by the decorated schemas. This ontology may be derived from the schema generated by the schema derivation module as described above. As described above, the ontology may be the result of a mapping from the derived health quality measurement schema into a semantic representation, such as by mapping schema elements to semantic representation classes, element attributes to class properties, and the like (e.g., mapping of common data types between the schema and the ontology). Entity names may be copied directly from the schema. The following example illustrates a mapping between a schema and an ontology as may result from this process:

```
TABLE 3
<define name=“representedOrganization”>
  <element>
    <name ns=“urn:hl7-org:v3”>representedOrganization</name>
    <attribute name=“classCode”>
      <data type=“NCName” />
    </attribute>
    <attribute name=“determinerCode”>
      <data type=“NCName” />
    </attribute>
    <ref name=“id” />
    <ref name=“name” />
    <ref name=“contactParty” />
  </element>
</define>
```

Table 3 illustrates an example type “representedOrganization” as defined in an XML schema with the attribute “classCode.” As result of the mapping of the schema to a semantic representation, the same type “representedOrganization” may be represented as follows:

```
TABLE 4
  <Class ID=“representedOrganization” xmlns=“http://www.w3.org/2000/01/rdf-schema#”>
    <rdfs: subClassOf>
      <owl:Class rdf:about=“#MetricConcept” />
    </rdfs:subClassOf>
  </Class>
<rdf:type rdf:resource=“http://www.w3.org/2002/07/owl#DatatypeProperty” /><rdfs:range
rdf:resource=“http://www.w3.org/2001/XMLSchema#NCName” />
</owl:FunctionalProperty>
  <owl:FunctionalProperty rdf:ID=“classCode”>
    <rdfs:domain>
      <owl:Class>
        <owl:unionOf rdf:parseType=“Collection”>
<owl:Class rdf:about=“#assignedPerson” />
<owl:Class rdf:about=“#observation” />
<owl:Class rdf:about=“#act” />
<owl:Class rdf:about=“#playingMaterial” />
<owl:Class rdf:about=“#qualityMeasureSet” />
<owl:Class rdf:about=“#contactParty” />
<owl:Class rdf:about=“#representedOrganization” />
<owl:Class rdf:about=“#patientPerson” />
<owl:Class rdf:about=“#patient” />
<owl:Class rdf:about=“#role” />
<owl:Class rdf:about=“#patientParticipant” />
<owl:Class rdf:about=“#playingDevice” />
<owl:Class rdf:about=“#roleParticipant” />
<owl:Class rdf:about=“#encounter” />
<owl:Class rdf:about=“#procedure” />
<owl:Class rdf:about=“#substanceAdministration” />
<owl:Class rdf:about=“#supply” />
</owl:unionOf>
      </owl:Class>
    </rdfs:domain>
```

As a result of this mapping, the “classCode” element is defined separately by its “domain.” In other words, the domain of “classCode” is all of the classes for which it is a property.

FIG. 5 illustrates a data flow 500 of generation of a semantic parser module in accordance with embodiments of the present invention. The semantic representation decorated schema 402, and the data model query decorated schema 406 may be compiled using a schema compiler 206 to generate a semantic parser module 208. The schema compiler 206 may be a software application configured to generate a compiler from a set of grammar, such as the semantic representation decorated schema 402, and the data model query decorated schema 406. In some embodiments, the schema compiler is “RelaxNG Compiler Compiler” (RelaxNGCC) published by the RelaxNGCC SourceForge Project. The schema compiler 206 may use the semantic representation decorated schema 402 to generate a “first pass” compiler that accepts a health quality measurement definition document and maps the document to a semantic representation (e.g., an RDF model). The schema compiler 206 may use the data model query decorated schema 406 to generate a “second pass” of the compiler that maps elements of a semantic representation model to particular queries against a target record datastore. The end result of this compilation process may be a semantic parser with classes for the different elements of the semantic representation decorated schema 402 and the data model query decorated schema 406. Each of these schemas may correspond to a “pass” of the semantic compiler. In the first pass, the semantic parser may turn a health quality measurement definition (e.g., an XML eMeasure) into a semantic representation (e.g., an RDF analog). In the second pass, the semantic parser may turn the semantic representation into a health quality measurement calculator module as described above with respect to FIG. 2, which includes a set of one or more queries that implement calculation of the health quality measurement metric against a set of medical records (e.g., a SPARQL query executed against records stored in an RDF datastore).

As an example of the process by which the schema compiler 206 may be employed, an XML element “myElement” may be identified during parsing along with a related attribute “firstAttribute” which has a value “abc”. Code may be added to the element to cause printing of the “firstAttribute” value when a particular element, “myElement”, is identified by the parser. When a document containing “myElement” is parsed, the value “abc” is printed to the console. In the case of the semantic parser, the “decorator component” may be used to add code for writing to a semantic representation (e.g., a representation in RDF format) in a first pass, based on knowledge of the schema and rules for translating from a markup language (e.g., XML) to the semantic representation. The decorator module may be used again for a second pass to turn annotations (e.g., the <spcc:*> tokens described above) which relate to specific queries (e.g., SPARQL query assertions) into executable query processor calls (e.g., Java®-implemented SPARQL query processor calls) in order to evaluate a health quality measurement definition document, with the end result producing a set of queries implementing the health quality measurement definition over a set of medical records data. An example of this semantic parsing process will now be described in further detail with respect to FIGS. 6-8.

### Example Use of the Semantic Parser

Turning now to FIGS. 6-8, an example dataflow is described for using a semantic parser module (e.g., a semantic parser as generated according to the embodiments described with respect to FIGS. 3-5) to generate a health quality measurement calculator module from an input health quality measurement definition document. The health quality measurement calculator module may implement the health quality measurement definition against a medical records datastore to determine an output value for a health quality measurement metric. FIG. 6 illustrates a data flow 600 of a first pass of a semantic parser module in accordance with embodiments of the present invention. As described above, the first pass of the semantic parser module may receive a health quality measurement definition document 602 and generate a semantic representation 604 of the contents of the health quality measurement definition document. For example, the semantic parser may receive a document in an XML format (e.g., an eMeasure document) and generate an RDF representation of the document. The XML document may be converted to the RDF representation by the code that was previously added to the derived schema by the decorator utility as described above with respect to FIGS. 3-5 (see, e.g., Table 1 above). The end result of this mapping is a set of elements of the input document mapped to a set of criteria query assertions, which may provide particular values that are relevant to the input health quality measurement definition document (e.g., particular diagnostic or procedure codes, patient demographic information, or the like). One example of this mapping for an example document is as follows:

TABLE 5

| Health Quality Measurement Definition | |
|---|---|
| Element | spcc:criteria query assertion |
| <templateId | ?template :root |
| root=“2.16.840.1.113883.3.560.1.5”> | “2.16.840.1.113883.3.560.1.5”\hat{ }\hat{ }xsd:NMTOKEN |
| <id root=“AF9EE784-50CF-413F-9082- | ?id :root “AF9EE784-50CF-413F-9082- |
| 41A3330511A1> | 41A3330511A1”\hat{ }\hat{ }xsd:string |
| <code code=“30954-2” displayName=“Results” | ?code :code “30954-2”\hat{ }\hat{ }xsd:NMTOKEN ; |

| | |
|---|---|
| codeSystem=“2.16.840.1.113883.6.1”> | :codeSystem |

| | |
|---|---|
| | “2.16.840.1.113883.6.1”\hat{ }\hat{ }xsd:NMTOKEN |
| <act classCode=“ACT” moodCode=“EVN” | qdm:act6 qdm:classCode “ACT”\hat{ }\hat{ }xsd:NCName . |
| isCriterionInd=“true”><!-- laboratory test | qdm:act6 qdm:isCriterionInd “true”\hat{ }\hat{ }xsd:boolean . |
| performed pattern --> | qdm:act6 qdm:moodCode “EVN”\hat{ }\hat{ }xsd:NCName . |
| <templateId | qdm:templateId8 rdf:type qdm:templateId . |
| root=“2.16.840.1.113883.3.560.1.5”/> | qdm:act6 qdm:hasTemplateId qdm:templateId8 . |
| | qdm:templateId8 qdm:root |
| | “2.16.840.1.113883.3.560.1.5”\hat{ }\hat{ }xsd:NMTOKEN . |
| <templateId | ?template :root |
| root=“2.16.840.1.113883.3.560.1.5”> | “2.16.840.1.113883.3.560.1.5”\hat{ }\hat{ }xsd:NMTOKEN |
| <id root=“AF9EE784-50CF-413F-9082- | ?id :root “AF9EE784-50CF-413F-9082- |
| 41A3330511A1> | 41A3330511A1”\hat{ }\hat{ }xsd:string |
| <code code=“30954-2” displayName=“Results” | ?code :code “30954-2”\hat{ }\hat{ }xsd:NMTOKEN ; |

| | |
|---|---|
| codeSystem=“2.16.840.1.113883.6.1”> | :codeSystem |

| | | “2.16.840.1.113883.6.1”\hat{ }\hat{ }xsd:NMTOKEN |
|---|---|---|
| <act classCode=“ACT” moodCode=“EVN” | | qdm:act10 rdf:type qdm:act . |
| isCriterionInd=“true”><!-- medication dispensed | | qdm:sourceOf19 qdm:hasAct qdm:act10 . |
| pattern --> | | qdm:act10 qdm:classCode “ACT”\hat{ }\hat{ }xsd:NCName . |
| | <templateId | qdm:act10 qdm:isCriterionInd “true”\hat{ }\hat{ }xsd:boolean |

| | |
|---|---|
| root=“2.16.840.1.113883.3.560.1.8”/> | . |
| | qdm:act10 qdm:moodCode “EVN”\hat{ }\hat{ }xsd:NCName |
| | . |
| | qdm:templateId10 rdf:type qdm:templateId . |
| | qdm:act10 qdm:hasTemplateId qdm:templateId10 . |
| | qdm:templateId10 qdm:root |
| | “2.16.840.1.113883.3.560.1.8”\hat{ }\hat{ }xsd:NMTOKEN . |

Table 5 illustrates how individual elements of the input health quality measurement definition document (e.g., individual elements defined in the XML) can be mapped to a semantic representation using a compiled schema that includes code to perform such a mapping (e.g., as described above with respect to the decorator module). This semantic representation may be processed in a second pass to evaluate a set of criteria against the semantic representation to identify a set of queries needed to implement the health quality measurement.

FIG. 7 illustrates a data flow 700 for performing a second pass of a semantic parser module in accordance with embodiments of the present invention. Once the semantic representation 604 (e.g., a document including a set of semantic representation criteria met by the input document) of the health quality measurement definition document has been generated, the semantic parser module 208 may proceed to map the semantic representation 604 onto a set of semantic representation actions which serve to map the data requested by the original input document onto a semantic representation datastore. This second pass involves selecting particular actions that are associated based on the criteria met by the input document. This mapping process may be performed using a health quality measurement ontology 404, such as described above with respect to FIG. 4. As described above, the semantic parser module 208 may include a schema which, when compiled by the schema compiler, maps an input set of semantic representation criteria (e.g., RDF criteria) to a set of actions against an RDF datastore (e.g., RDF actions). These actions may define queries to be performed against the RDF datastore. An example of these actions and attendant queries are as follows:

TABLE 6

| spcc:action query assertion | Corresponding ontology of the HER |
|---|---|
| ?result qi:hasEncounter ?encounter | :hasEncounter |

| | |
|---|---|
| a | owl:ObjectProperty ; |

rdfs: domain

| | |
|---|---|
| [ a | owl:Class ; |

owl:unionOf (:Finding :Diagnosis

:LaboratoryResult :Medication)

] ;

rdfs:range :PatientEncounter .

| | |
|---|---|
| ?result qi:loincCode ?ptResultCode . | :loincCode |

| | |
|---|---|
| a | owl:DatatypeProperty ; |

rdfs:domain :LaboratoryResult ;
rdfs:range xsd:string .

| | |
|---|---|
| ?result qdm:hasTaxa | qdm:hasTaxa |

| | | |
|---|---|---|
| ?taxonomyResultCode . | a | owl:ObjectProperty ; |

rdfs:domain

| | |
|---|---|
| [ a | owl:Class ; |

owl:unionOf (:Fact :PatientEncounter)
] ;

rdfs:range qdm:Taxonomy .

| | |
|---|---|
| filter ( extf:codeMatch (?resultCode, | extf:codeMatch( ) is a boolean SPARQL filter function |
| ?taxonomyResultCode, ?ptResultCode) ) | comparing the OID first argument to the lookup OID of the |
| | EHR-stored (result) code for the given taxonomy. |

The result of executing the second pass of the semantic parser module in this example is the construction of a query to be executed over the target datastore. For example, a type of lab result criteria may be established by querying the semantic representation of the health quality measurement document (e.g., a numerator element of the metric) for a particular code, such as a Logical Observation Identifiers Names and Codes (LOINC) code. to ask “was the LOINC code for the lab result criterion=‘1234’?”. Since there are many possible terms that may be used in the metric, this particular code criterion establishes which term of the metric is under consideration. The second-pass of the semantic parser, having established that the criterion for lab result is satisfied, may publish the query to be used against a set of medical records data linking the lab result with correct LOINC code to the observation and ultimately to the encounter and person.

The result of the evaluation of the health quality measurement definition document may be represented as a generated health quality measurement calculator module 210, which may include one or more queries to be executed against the datastore. In some embodiments, the health quality measurement calculator module 210 is provided to another application for execution, though in the present example this module 210 is considered to be a standalone application that, when executed, retrieves the relevant data from a datastore and provides an output of a metric related to the original health quality measurement definition document. An example generated query is shown below with respect to Table 5:

```
TABLE 7
select (count(distinct ?encounter) as ?Encounters) {
OPTIONAL {
  Let ( ?bool6 := “true”\hat{ }\hat{ }xsd:boolean ) .
  OPTIONAL {
    Let ( ?bool7 := “true”\hat{ }\hat{ }xsd:boolean ) .
    Let ( ?months :=“12”\hat{ }\hat{ }<http://www.w3.org/2001/XMLSchema#NMTOKEN>)?encounter
qi:cptCode ?encCode .
?encounter qdm:hasTaxa ?taxonomyEncounter .
filter ( extf:codeMatch
(“2.16.840.1.113883.3.464.0001.231”\hat{ }\hat{ }<http://www.w3.org/2001/XMLSchema#NMTOKEN>,
?taxonomyEncounter, ?encCode) )
  }
  OPTIONAL {
    Let ( ?bool8 :=“true”\hat{ }\hat{ }xsd:boolean ) .
    ?medOrd qi:hasEncounter ?encounter .
?medOrd qi:rxNormCode ?ptMedOrderCode .
?medOrd qdm:hasTaxa ?taxonomyMedOrd .
filter ( extf:codeMatch
(“2.16.840.1.113883.3.464.0001.373”\hat{ }\hat{ }<http://www.w3.org/2001/XMLSchema#NMTOKEN>,
?taxonomyMedOrd, ?ptMedOrderCode) )
  }
  OPTIONAL {
    Let ( ?bool9 :=“true”\hat{ }\hat{ }xsd:boolean ) .
    ?medDisp qi:hasEncounter ?encounter .
?medDisp qi:rxNormCode ?ptMedDispensedCode .
?medDisp qdm:hasTaxa ?taxonomyMedDisp .
filter ( extf:codeMatch
(“2.16.840.1.113883.3.464.0001.373”\hat{ }\hat{ }<http://www.w3.org/2001/XMLSchema#NMTOKEN>,
?taxonomyMedDisp, ?ptMedDispensedCode) )
  }
  OPTIONAL {
    Let ( ?bool10 := “true”\hat{ }\hat{ }xsd:boolean ) .
      ?medAct qi:hasEncounter ?encounter .
?medAct qi:rxNormCode ?ptMedicationCode .
?medAct qdm:hasTaxa ?taxonomyMedAct .
filter ( extf:codeMatch
(“2.16.840.1.113883.3.464.0001.373”\hat{ }\hat{ }<http://www.w3.org/2001/XMLSchema#NMTOKEN>,
?taxonomyMedAct, ?ptMedicationCode) )
  }
  ?result qi:hasEncounter ?encounter .
?result qi:loincCode ?ptResultCode .
?result qdm:hasTaxa ?taxonomyResultCode .
filter ( extf:codeMatch
(“2.16.840.1.113883.3.464.0001.250”\hat{ }\hat{ }<http://www.w3.org/2001/XMLSchema#NMTOKEN>,
?taxonomyResultCode, ?ptResultCode) )
  filter ( extf:and(?bool7,extf:or(?bool8,?bool9,?bool10)))
}
OPTIONAL { ...
```

The “qi:” prefix refers to a target datastore (e.g., a quality instance namespace), the “qdm:” prefix refers to an ontology for a particular namespace (e.g., a quality data model) namespace, combined with definitions used in the quality instance namespace and an ontology derived by the decorator utility as inferred from the original collection of health quality measurement input documents.

The “?resultCode” variable from the “spcc:spql” section in the example above (see Tables 2 and 4) has now been expanded in the query below, see, for example, the first parameter to the last “extf:codeMatch( )” method. The query searches for incidence of the prescription, order or administration of a medication identified by the OID 2.16.840.1.113883.3.464.0001.373 in the population of patient encounters in the target data set, where the type of the encounter is identified by the OID 2.16.840.1.113883.3.464.0001.231. The emitted query is ready to query over a medical record data store. The query processors may require a prologue in the query listing all of the namespace prefixes used by the query; or the query processor may prepend these prefix definitions based on the namespaces associated with the model being queried.

FIG. 8 illustrates a data flow 800 for executing a health quality measurement calculator module 210 against a medical record database 802 to determine a health quality metric result 804 in accordance with embodiments of the present invention. As described above, embodiments may generate a health quality measurement calculator module 210 that includes one or more queries for data relevant to calculating a health quality metric. In some embodiments, the medical record database 802 may be converted to a semantic representation, such as an RDF model format, as described above with respect to FIGS. 2-5. Execution of the health quality measurement calculator module 210 may include querying the datastore using the queries defined as described above with respect to FIG. 7, and processing the data returned by those queries to generate a numerical output for the metric. For example, a particular health quality measurement metric may include certain numerator and denominator values, and the queries executed by the health quality measurement calculator module 210 may retrieve these values and perform the mathematical computation to arrive at the metric result.

Although a given metric may define a “Summary Calculation,” each health quality measurement metric may not necessarily provide a single result. As a particular example, an example health quality measurement calculator may perform various calculations as defined within the health quality measurement definition document. Some rules for performing these calculations may be as follows:
1. Calculate the final denominator by adding data from all records that meet denominator criteria.
2. Subtract from the final denominator all data sets that do not meet numerator criteria yet also meet exclusion criteria. Some measures may not have exclusion criteria.
3. The performance calculation may be based on a measure scoring type value indicated in the measure definition document:
   For “Proportion” measures, the calculation is the number meeting numerator criteria divided by the final denominator.
   For “Ratio” and “Continuous Variable” measures, follow the calculation instructions in the Data Aggregation header information above, if present.
4. For measures with multiple denominators, repeat this process for each denominator and report each result separately.
5. For measures with multiple patient populations, repeat this process for each patient population and report each result separately.
6. For measures with multiple numerators, calculate each numerator separately within each population using the paired exclusion.

The health quality metric calculator module 210 may produce results for Populations, Exclusions, Numerators and Denominators as defined in the health quality measurement definition document. These results may then subsequently be combined in a report according to the reporting requirements of the health quality measurement definition. Some health quality measurement definition documents may be defined as metric type of “Proportion,” in which case the numerators and denominators are reported separately (not as the result of a division). For other health quality measurement definition documents, metrics may be of type “Ratio” where the result of dividing the numerator and denominator are reported. Although the type “Ratio” implies division, the data aggregation instructions are not necessarily in a machine-readable form, and the specific method of aggregation and reporting are outside the scope of the calculation of the metric. For example, according to a particular “Data aggregation” instruction from eMeasure document NQF_Retooled_Measure_{—}0138.xml, the instructions might read as follows:
“NQF-endorsed version: This measure is reported as a rate comprised of the number of catheter-associated urinary tract infections per 1,000 urinary catheter days for each hospital unit location included in scope for the measure.”

One or more health quality measurement calculator modules 210 may be embedded in a reporting application. These health quality measurement calculator modules 210 may produce results for particular Populations, Exclusions, Numerators and Denominators. Such a reporting application may be responsible for combining the results appropriately and generating the final report. For example, a spreadsheet may be designed to generate a report where the formula for a given cell contains a call-out to an external database or to a remote web service to retrieve data upon which the report calculations depend.

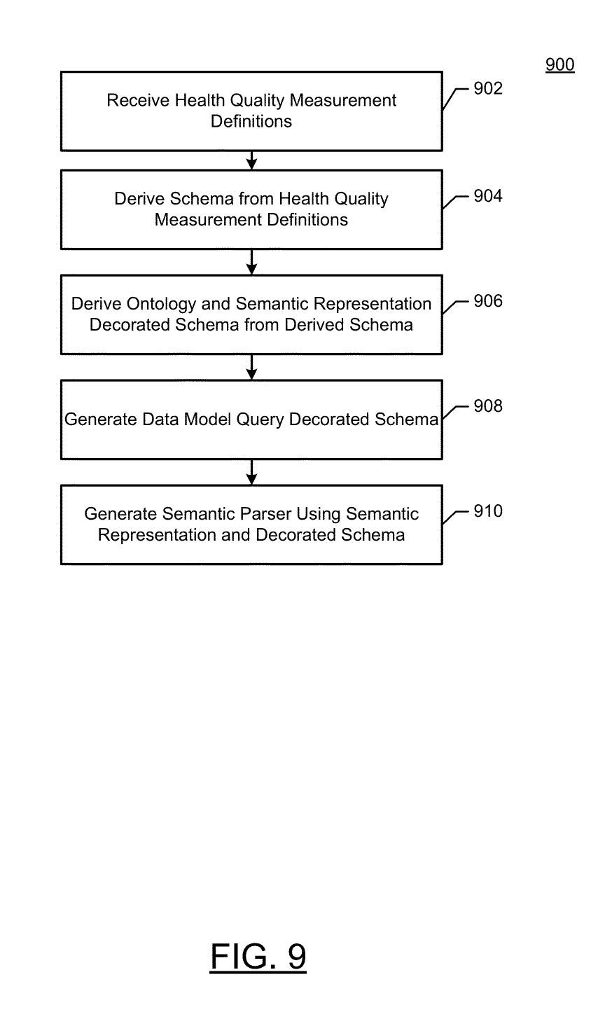

FIG. 9 is a flow diagram of an example method 900 for generating a semantic parser in accordance with example embodiments of the present invention. As described above with respect to FIGS. 3-5, a semantic parser may be generated by analyzing a set of input documents to derive a common schema for the input documents, and then decorating and compiling the schema to generate the semantic parser. The semantic parser may then be used to parse input documents provided according to the common schema to map the input documents to a semantic representation datastore. Embodiments of the method 900 may be performed by an apparatus, such as the apparatus 102 described with respect to FIG. 1, or executed by a processor such as the processor 112 described with respect to FIG. 1.

At action 902, a set of health quality measurement definition documents may be received. As described above, these health quality measurement definition documents may be provided according to a markup language, such as XML. In some embodiments, these health quality measurement definition documents are eMeasure documents, such as those provided by the HHS. At action 904, a schema is derived from these health quality definition documents. For example, the schema may be derived by an application such as “trang” to generate an output of a derived schema representing a common schema for the input health quality measurement definition documents.

This derived schema may be provided to a decorator utility where, at action 906, an ontology and semantic representation may be derived from the schema, such as described above with respect to FIG. 4. The semantic representation decorated schema may provide a mapping between elements of the schema and elements of a semantic representation model (e.g., an RDF model) for the schema. The ontology may establish a grammar for the RDF representation of the schema. Decoration of the derived schema may include adding code portions (e.g., Java® code) to the schema to facilitate the mapping of the schema element to the RDF representation.

At action 908, a data model query decorated schema may be generated. As described above, this data model query decorated schema may also be generated by the decorator utility. The data model query decorated schema may include code portions (e.g., Java® code) that maps semantic representation criteria (e.g., RDF criteria) to a set of queries against a datastore (e.g., a medical records datastore).

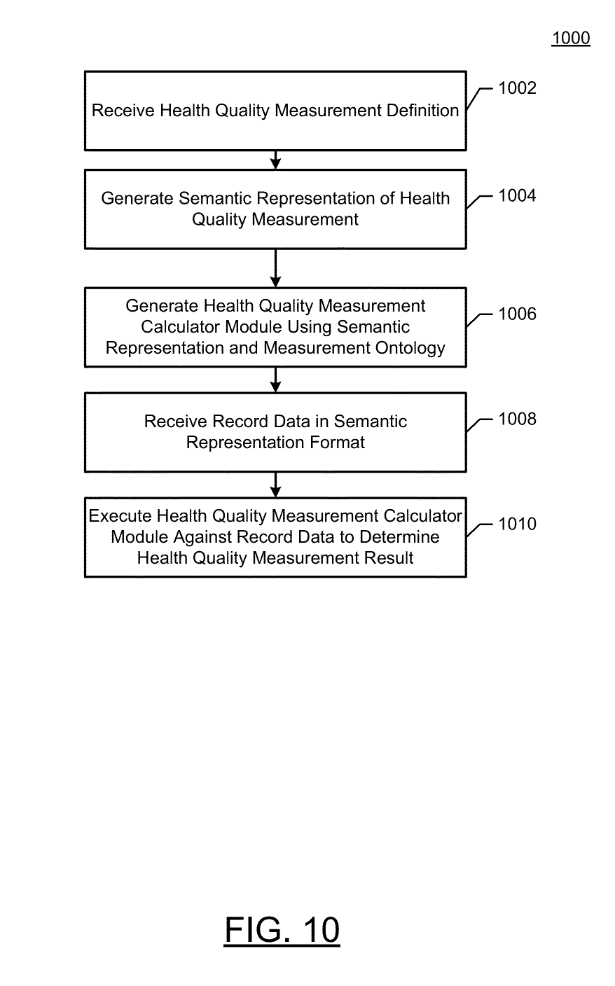

At action 910, the schemas derived at action 906 and 908 may be compiled to generate a semantic parser which is operable to receive as input a particular health quality measurement document, and parse the document to generate a health quality measurement calculator module which executes one or more queries against a medical records datastore to provide a calculation defined within the input document. An example method for using such a semantic parser to generate the health quality measurement calculator module is described further below with respect to FIG. 10.

FIG. 10 is a flow diagram of an example method 1000 for generating a health quality measurement calculator application using a semantic parser in accordance with example embodiments of the present invention. As described above with respect to FIGS. 6-8, a semantic parser may be used to generate a health quality measurement calculator module from an input health quality measurement definition document. Embodiments of the method 1000 may be performed by an apparatus, such as the apparatus 102 described with respect to FIG. 1, or executed by a processor such as the processor 112 described with respect to FIG. 1.

At action 1002, an input health quality measurement definition document is received. This input document may be a health quality measurement definition document as described above with respect to FIGS. 2-9 (e.g., an eMeasure document). Such a document may be provided according to a markup language format, such as XML. This document may be one of a group of documents originally used to generate a semantic parser, as described above with respect to FIGS. 2-9.

At action 1004, a semantic representation of the received health quality measurement definition document is received. Generation of this semantic representation may involve a “first pass” of the semantic parser as described above with respect to FIG. 6. This semantic representation may include a set of semantic representation criteria which map the received input document to a semantic representation model (e.g., an RDF model).

At action 1006, the semantic parser may use the semantic representation and a health quality measurement ontology (e.g., a health quality measurement ontology derived as described above with respect to FIG. 9) to generate a health quality measurement calculator module. Generation of the health quality measurement calculator module may include mapping the set of criteria defined within the semantic representation to a set of queries to be performed across a semantic representation of a medical records datastore. Generation of the health quality measurement calculator may correspond to a “second pass” of the semantic parser as described above with respect to FIG. 7.

At action 1008, a set of record data may be accessed in a semantic representation format. For example, a semantic representation model of a set of medical records may be received, or the method 1000 may access a predefined database containing the medical record datastore.

At action 1010, the health quality measurement calculator may be executed against the set of medical record data to derive data for calculating one or more health quality metrics defined in the originally input health quality metric definition document. Execution of the health quality measurement calculator may include execution of one or more queries defined as actions in response to the criteria established upon creating the semantic representation of the health quality measurement definition document. These queries may be performed to retrieve the relevant data from the medical records datastore, and calculations may be performed on said relevant data to generate one or more metrics as output. These metrics may be provided to users via a display, reported to an external system (e.g., a compliance measurement or auditing system), output via a spreadsheet, or via various other reporting methods and systems for providing such data.

It will be understood that each block of the flowcharts, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for implementing a health quality measurement comprising:
receiving one or more health quality measurement definitions, at least a portion of each health quality measurement comprising markup language definitions defining one or more calculation parameters for a health quality metric;
parsing, using a processor, the one or more health quality measurement definitions to derive a semantic representation of the one or more calculation parameters;
parsing the semantic representation of the one or more calculation parameters in conjunction with a health quality measurement ontology derived from at least the one or more health quality measurement definitions to generate a health quality measurement calculator application; and
executing the health quality measurement calculator application against a set of healthcare data to determine the health quality metric for the healthcare data.

2. The method of claim 1, wherein the health quality measurement definitions and the semantic representation are parsed by a semantic parser, wherein the semantic parser is generated by a method comprising:
receiving a plurality of health quality measurement definitions, the plurality of health quality measurement definitions comprising at least the one or more health quality measurement definitions, each of the plurality of health quality measurement definitions being associated with a respective set of markup language definitions;
deriving a health quality measurement schema for the plurality of health quality measurement definitions using at least the respective sets of markup language definitions;
deriving the health quality measurement ontology from the plurality of health quality measurement definitions;
decorating the health quality measurement schema with one or more source code portions to generate a decorated schema; and
generating the semantic parser by compiling the decorated schema.

3. The method of claim 2, wherein a first portion of the decorated health quality measurement schema comprises program code that, when compiled and executed, receives the one or more health quality measurement definitions and generates the semantic representation of the one or more health quality measurement definitions.

4. The method of claim 3, wherein a second portion of the decorated health quality measurement schema comprises program code that, when compiled and executed, generates the health quality measurement calculator by parsing the semantic representation.

5. The method of claim 1, wherein the semantic representation is a Resource Description Framework (RDF) data model.

6. The method of claim 1, wherein the set of healthcare data is stored in a semantic representation format.

7. The method of claim 1, wherein parsing the semantic representation comprises executing a query against the semantic representation of the one or more health quality measurement definitions to determine whether the semantic representation satisfies one or more criteria.

8. The method of claim 7, wherein the one or more criteria define one or more queries to be executed against the set of healthcare data.

9. The method of claim 9, wherein executing the health quality measurement calculator application comprises executing the one or more queries against the set of healthcare data.

10. An apparatus comprising processing circuitry configured to:
receive one or more health quality measurement definitions, at least a portion of each health quality measurement comprising markup language definitions defining one or more calculation parameters for a health quality metric;
parse the one or more health quality measurement definitions to derive a semantic representation of the one or more calculation parameters;
parse the semantic representation of the one or more calculation parameters in conjunction with a health quality measurement ontology derived from at least the one or more health quality measurement definitions to generate a health quality measurement calculator application; and
execute the health quality measurement calculator application against a set of healthcare data to determine the health quality metric for the healthcare data.

11. The apparatus of claim 10, wherein the health quality measurement definitions and the semantic representation are parsed by a semantic parser, and wherein apparatus is configured to generate the semantic parser by:
receiving a plurality of health quality measurement definitions, the plurality of health quality measurement definitions comprising at least the one or more health quality measurement definitions, each of the plurality of health quality measurement definitions being associated with a respective set of markup language definitions;
deriving a health quality measurement schema for the plurality of health quality measurement definitions using at least the respective sets of markup language definitions;
deriving the health quality measurement ontology from the plurality of health quality measurement definitions;
decorating the health quality measurement schema with one or more source code portions to generate a decorated schema; and
generating the semantic parser by compiling the decorated schema.

12. The apparatus of claim 11, wherein a first portion of the decorated health quality measurement schema comprises program code that, when compiled and executed, receives the one or more health quality measurement definitions and generates the semantic representation of the one or more health quality measurement definitions.

13. The apparatus of claim 12, wherein a second portion of the decorated health quality measurement schema comprises program code that, when compiled and executed, generates the health quality measurement calculator by parsing the semantic representation.

14. The apparatus of claim 10, wherein the semantic representation is a Resource Description Framework (RDF) data model.

15. The apparatus of claim 10, wherein the set of healthcare data is stored in a semantic representation format.

16. The apparatus of claim 10, wherein the apparatus is configured to parse the semantic representation by executing a query against the semantic representation of the one or more health quality measurement definitions to determine whether the semantic representation satisfies one or more criteria.

17. The apparatus of claim 16, wherein the one or more criteria define one or more queries to be executed against the set of healthcare data.

18. The apparatus of claim 17, wherein executing the health quality measurement calculator application comprises executing the one or more queries against the set of healthcare data.

19. A computer program product comprising at least one non-transitory computer-readable storage medium bearing computer program instructions embodied therein for use with a computer, the computer program instructions comprising program instructions configured to:
receive one or more health quality measurement definitions, at least a portion of each health quality measurement comprising markup language definitions defining one or more calculation parameters for a health quality metric;
parse the one or more health quality measurement definitions to derive a semantic representation of the one or more calculation parameters;
parse the semantic representation of the one or more calculation parameters in conjunction with a health quality measurement ontology derived from at least the one or more health quality measurement definitions to generate a health quality measurement calculator application; and
execute the health quality measurement calculator application against a set of healthcare data to determine the health quality metric for the healthcare data.

20. The computer program product of claim 19, wherein the health quality measurement definitions and the semantic representation are parsed by a semantic parser, and wherein apparatus is configured to generate the semantic parser by:
receiving a plurality of health quality measurement definitions, the plurality of health quality measurement definitions comprising at least the one or more health quality measurement definitions, each of the plurality of health quality measurement definitions being associated with a respective set of markup language definitions;
deriving a health quality measurement schema for the plurality of health quality measurement definitions using at least the respective sets of markup language definitions;
deriving the health quality measurement ontology from the plurality of health quality measurement definitions;
decorating the health quality measurement schema with one or more source code portions to generate a decorated schema; and
generating the semantic parser by compiling the decorated schema.
